(19) United States
(12) Patent Application Publication
(10) Pub. No.: US 2014/0164175 A1
(43) Pub. Date: Jun. 12, 2014

(54) SHOPPING CART LIST

(71) Applicant: RAWLLIN INTERNATIONAL INC., Tortola (VG)

(72) Inventor: Vladimir V. Kitlyar, Sankt-Petersburg (RU)

(73) Assignee: RAWLLIN INTERNATIONAL INC., Tortola (VG)

(21) Appl. No.: 13/710,898

(22) Filed: Dec. 11, 2012

(51) Int. Cl. G06Q 30/06

(52) U.S. Cl. CPC G06Q 30/0633
USPC 705/26.8

(57) ABSTRACT

Shopping cart lists at a retail store are provided relative to limits. A customer can use their own smart phone, for example, or a proprietary store device to scan products as they are added to a shopping cart. Prior to adding products, the phone or device can be personalized with the customer's payment information. The device can determine a transaction limit based on the customer's payment information. As products are added to the shopping cart, the customer can be alerted regarding the reaching of the transaction limit. The device can also give suggestions to the customers of items to be removed from the shopping cart to stay within the transaction limit.

### TECHNICAL FIELD

This application relates to shopping and more particularly to generating shopping cart lists in real time that incorporate shopper transaction limits.

### BACKGROUND

The brick and mortar shopping experience had remained unchanged for many years. Customers selected items they wished to purchase. Customers either gathered the items themselves, or gathered product identifiers that they could then take to a cashier to pay for. After paying for the products at the cashier, customers were free to leave the store with their products. One bottleneck in this traditional brick and mortar shopping experience is the check out process. Depending on the day of the week, the time of day, or the season, retail stores can vary in how busy they are. While appropriate staffing, e.g., additional cashiers available during busy times, can help alleviate the pressures that occur when a large amount of customers desire to check out in unison, additional cashiers cost money to employ, or are not always available.

A generally pleasant shopping experience for a customer while selecting products and adding them to their shopping cart can quickly change to a highly negative experience if the customer is forced to wait for an extended period of time to check out. This negative experience can be compounded for shoppers that are working within a transaction limit, such as those shoppers with limited funds available in a debit or a credit account they wish to use to conduct the transaction. If a customer desires to checkout, they may learn than the subtotal of the products they wish to purchase is greater than their transaction limit. The customer could try to figure out what items to remove from the cart, and attempt to cancel their purchase of those items; or in frustration, they may choose to abandon the entire cart of items and walk out of the store. In addition, the confusion related to determining how to proceed while staying within a transaction limit can disrupt other customers desiring to checkout themselves.

With the advent of online shopping, consumers can choose to avoid the brick and mortar experience altogether and instead purchase a product online. In most cases, online customers do not have to wait in line to check out, have a real-time list of products within their shopping cart, and can purchase products on their own timeline. However, online shopping does carry inherent disadvantages. For example, a customer cannot physically see the product they are purchasing online and must rely on photos, videos, or a written description of the product. In addition, online shoppers most likely have to wait for the product to be packaged and shipped before receiving the product, while a brick and mortar shopper can take the product with them immediately.

While the traditional brick and mortar shopping experience has distinct advantages in seeing the product, and catering to instant gratification in taking the product with you upon exit of the store, processing brick and mortar transactions is traditionally less convenient than processing an online transaction. For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to real-time generation of shopping cart lists at a retail store. Identification data, including information representative of a user identity associated with a user of a personal shopping device can be received, wherein the identification data includes payment preference data associated with the user identity. A transaction limit can be determined based on the payment preference data. Shopping item data representing a set of items represented in shopping cart data from the personal shopping device can be received. Display data can be customized for a customized display on the personal shopping device based on the shopping item data and the transaction limit.

In another embodiment, a personal shopping device can comprise a personalization component that can receive identification data representing a user identity determined to be associated with a user of the personal shopping device, wherein the identification data includes payment preference data associated with the user identity. A transaction component can send authorization data to a financial transaction system, wherein the authorization data includes the identification data, and receive a transaction limit from the financial transaction system, in response to the sending. A scanning component can scan products, wherein in response to a product of the products being scanned, the product is added to a set of shopping cart items. A display component can facilitate presentation of the set of shopping cart items and the transaction limit.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates example flow diagram for implementing and using personal shopping devices;

FIG. 2 illustrates an example personal shopping device;

FIG. 3 illustrates an example personal shopping device including a subtotal component;

FIG. 4 illustrates an example personal shopping device including a notification component;

FIG. 5 illustrates an example personal shopping device including a budget component;

FIG. 6 illustrates an example flow diagram method for generating and using shopping cart lists;

FIG. 7 illustrates an example flow diagram method for generating and using shopping cart lists including determining a subtotal;

FIG. 8 illustrates an example flow diagram method for generating and using shopping cart lists including triggering user alerts;

FIG. 9 illustrates an example flow diagram method for generating and using shopping cart lists including generating and displaying budget lists;

FIG. 10 illustrates an example block diagram of a computer operable to execute the disclosed architecture; and

FIG. 11 illustrates an example schematic block diagram for a computing environment in accordance with the subject specification.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Systems and methods disclosed herein relate to real-time generation of shopping cart lists at a retail store. A customer can use their own smart phone, for example, or a proprietary store device to scan products as they are added to a shopping cart. Prior to adding products, the phone or device can be personalized with the customer's payment information. The device can determine a transaction limit based on the customer's payment information. As products are added to the shopping cart, the customer can be alerted regarding the reaching of the transaction limit. The device can also give suggestions to the customers of items to be removed from the shopping cart to stay within the transaction limit.

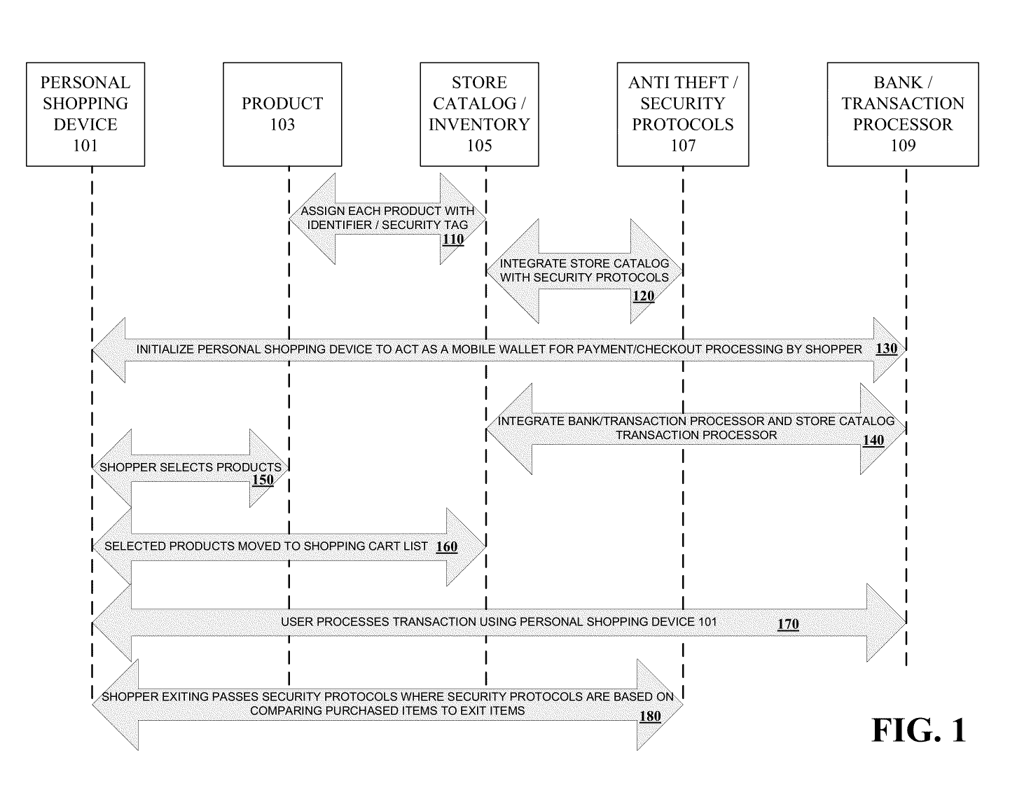

Referring now to FIG. 1 there is illustrated example flow diagram for implementing and using a related fast-track payment system. The depicted steps illustrate exchanges of information that can be pre-requisites for implementing the real-time generation of shopping cart lists as well as steps in using the implemented shopping cart list system. Steps 110 and 120 are perquisites for using the fast track system within a retail environment, as the products, store catalog, and security protocols are established to be later used by personal shopping device 101.

Personal shopping device 101 can be a proprietary device that includes the functionality as described herein or alternatively can be a consumer electronic device capable of communicating with the store. For example, a tablet or a smart phone with radio capabilities can communicate with the store, e.g., through an application, using a local wireless router, a wireless service provider, etc. In an example proprietary device system, a bin of proprietary devices can be placed near the entrance of the retail store, where a consumer grabs the proprietary device upon entrance to the retail store, and personalizes it as described in greater detail with regard to step 130 below.

At 110, each product 103 in a store catalog 105 can be assigned with a unique product identifier and/or security tag. For example, the assigning can be based off a uniform product code (“UPC”), a stock keeping unit (“SKU”), an attached short range radio frequency identification (“RFID”) tag, a long range RFID tag, or a magnetic tag. In one implementation, each individual product, including those products that are identical, can be outfitted with a unique identification such that store catalog 105 can uniquely identity individual variations of each product. In another implementation, the unique identifier can be shared by identical products. By establishing a store catalog/inventory 105 of products correlated with a unique identifier, the catalog can later be used by, for example, anti theft/security protocols 107 in securely processing the transaction. It can be appreciated that products can be assigned multiple identifiers. For example, the product can be assigned a UPC capable of being scanned at step 150 by personal shopping device 101, and also a magnetic tag capable of being scanned at a security gate by a security scanner.

At 120, store catalog/inventory 105 can be integrated with anti theft security protocols 107. For example, an anti-theft gate or area can be established at the exits of the store. At the gate, a scanner can be placed capable of reading the unique product identifiers described above. For example, if the unique identifier is a UPC, an image scanner or a video scanner can take photos or videos of products at a security checkpoint and determine the product identified by the scanner using the store catalog. In another example, an RFID scanner can read RFID tags, and then used the scanned information to identify the product the RFID tag is referencing. In another example, scanning the RFID tag returns the identity of the product as the identity is stored within the tag. It can be appreciated that many different types of scanning and identifier solutions are possible in implementing security protocols.

At 130, a consumer can begin the shopping process by initializing personal shopping device 101 to act as a mobile wallet for payment/checkout processing by the shopper. For example, using bank/transaction processor 109, the shopper can be identified, and in one example given a purchase limit. A customer could sign into personal shopping device 101 using a password, a personal identification number (“PIN”), a thumb print, a fingerprint, facial recognition software, etc, where a shopper profile already exists with preferred payment instructions, such as a specific debit card, credit card, or checking account which the shopper wants to use to process the transaction. In another example, the personal shopping device 101 can have a card reader on the device that can scan a physical card such as a debit card or a credit card. Bank 109 can then authorize prospective charges to the card, by, for example, placing a hold of funds on the account until a transaction is completed or abandoned. In one example, the shopper can authorize personal shopping device 101 to place a specified amount on hold. It can be appreciated that a vendor can have some certainty that an amount placed on hold with credit or debit provider guarantees the funds are available later at checkout. Thus, a credit or charge limit, e.g., transaction limit, can be established by the shopper, the bank or the retail store.

At 140, the bank/transaction processor 109 can be integrated with store catalog 105, such that the store catalog 105 can communicate transaction terms directly with bank/transaction processor and personal shopping device 101 can strictly communicate with the store. In this sense, access can be restricted to Bank/Transaction processor 109 to a single point of contact. It can be appreciated that in some instance, by limiting communications to a single point of contact, the security of transactions can be improved.

At 150, a shopper can begin selecting, e.g., scanning, products they wish to purchase. For example, a customer could scan a SKU, a UPC, an RFID tag, a magnetic tag, etc. The identifier associated with the product can be stored on personal shopping device 101 for communication at step 160. It can be appreciated that communication at 160 can occur dynamically as products are scanned at 150. As products are scanned or selected at 150, they can be placed inside a cart, carried, etc. In some systems, such as those using RFID or magnetic tags, products can be concealed and still later detected at a security gate. It can be appreciated that those systems relying on photographic imagery or video imagery may not allow for concealing products after selection. In some implementations, as the product is selected, information about the product can be displayed on personal shopping device 101, such as pricing, subtotals, quantity, additional product information, a link to a manufacturer web site, a product set of frequently asked questions (“FAQs”), etc. In another implementation, products can be scanned or selected as items the shopper wishes to return to the shelf. For example, after a shopper has scanned an item, they may no longer wish to purchase the item. By scanning the item, the item can then be removed from a corresponding shopping cart list as described more fully below with regard to step 160.

At 160, products selected at 150 can be moved to a shopping cart list. The shopping cart list can aggregate the unique product identifiers associated with each product added to the list for later use at a security checkpoint when the shopper is exiting the store. In addition, as the shopping list is dynamically updated, the shopper can be informed via personal shopping device 101 of the subtotal of items in the cart, or whether a specific product is actually on the shopping cart list. For example, a child could add or remove items from the shopping cart without a guardian's knowledge, and the guardian may wish to consult the shopping cart list to determine if a product in the shopping cart is actually on the shopping cart list. In a related application, systems and methods are disclosed for a smart shopping cart capable of identifying products within the cart.

At 170, the shopper using personal shopping device 101 can process the transaction, using just personal shopping device 101. For example, the payment terms authorized at step 130 can be used to complete the transaction by charging a debit card, credit card, withdrawing from a checking account, etc. The shopper using personal shopping device 101 is not required to meet with an automated or non-automated cashier to close the transaction. In one example, a shopper that has previously established a hold of funds on their selected method of payment does need to further present the method of payment and the transaction can be processed if within the transaction limit, e.g., the amount of funds on hold. Thus, the shopper can be anywhere within the store to close the transaction. This can save the shopper a significant amount of time as items are not needed to be rescanned, subtotaled, and paid for under the traditional retail experience. At this stage, a receipt can be generated. The receipt can be printed on the personal shopping device, emailed to an email account associated with the shopper's identity, or saved and associated with the shopper's identity within the store.

At 180, a shopper exiting the store can pass through security protocols 107. The shopping cart, shopping bag, or the shopper themselves can be scanned to determine the products within the cart, bag, shopper. For example, security zones can be established at the store's exit where an image scanner, a video scanner, an RFID scanner, and/or a magnetic scanner, for example, can work individually or in tandem to determine an exit list. The exit list is a list of the actual products the shopper is leaving the store with. The shopping cart list which was subtotaled and paid for at step 170 can then be compared to the exit list. If the two lists don't match, many different solutions can be implemented. For example, if the shopping cart list, e.g., the list of items the shopper paid for, does not include items in the exit list, the shopper can be immediately billed for the unpaid for items. Shoppers can agree to have their method of payment charged for any items not previously paid for, and can be notified of the additional charges. In another example, an alarm can be triggered that notifies store personnel of a potential theft. In an example where the shopper paid for items that are not in the exit list, the transaction can be modified to provide a credit to the shopper.

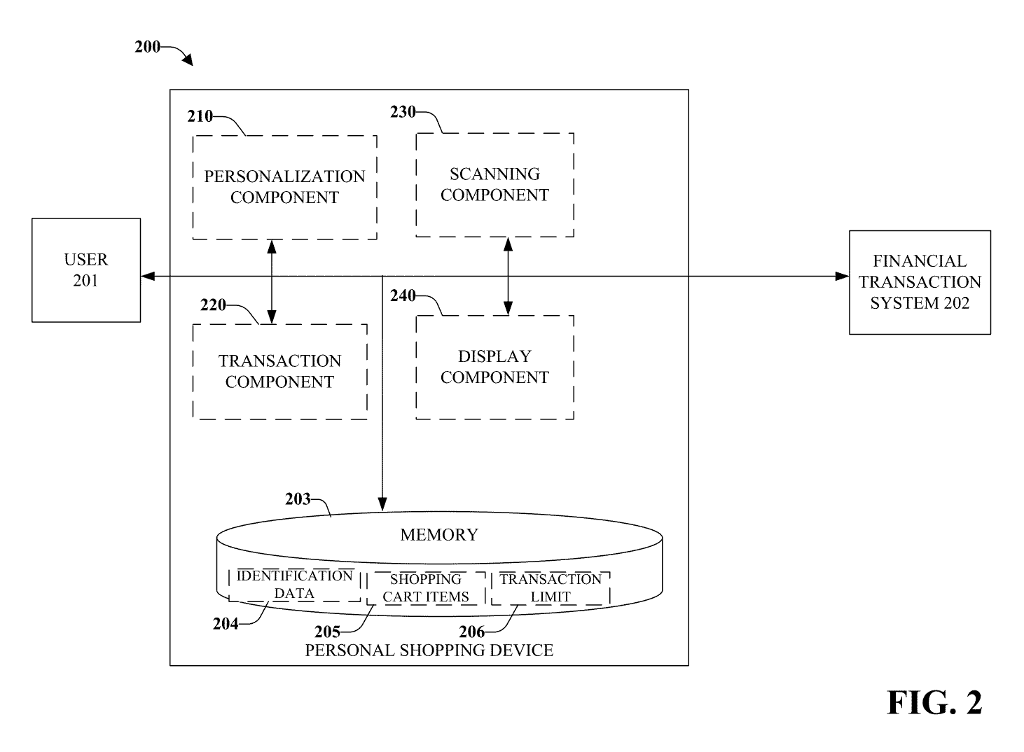

Referring now to FIG. 2, there is illustrated an example personal shopping device. Personal shopping device 200 can be a smart phone, tablet computer, personal computer, proprietary store device, a transponder device, etc. Personal shopping device 200 can contain a personalization component 210, a transaction component 230, a scanning component 230, a display component 240 and a memory 203. Personal shopping device 200 can communicate with a user 201 of the device through device inputs, such as a keypad, touch screen, fingerprint scanner, magnetic scanner, etc. Personal shopping device 200 can also be in communication with a financial transaction system 202, where the financial transaction system 202 can be a financial services provider, or an intermediary such as a secure store system that can be relay messages to and from a financial services provider.

Personalization component 210 can receive identification data representing a user identity determined to be associated with a user of the personal shopping device, wherein the identification data includes payment preference data associated with the user identity. For example, payment preference data can include a debit card, a credit card, a store credit account, etc., that the customer wishes to use to process a transaction. Transaction component 220 can send authorization data to a financial transaction system, wherein the authorization data includes the identification data, and receive a transaction limit from the financial transaction system, in response to the sending. For example, a credit limit minus a current balance could establish a transaction limit for a credit card or credit account. In another example, a current available funds amount can establish a transaction limit for a debit account. In another example, the transaction limit can be established by the shopper authorizing a financial institution or other payment processor to place a hold of funds, for a specified amount, on the payment account. The payment account receiving the hold can be a credit account, debit account, checking account and routing information, electronic wallet payments, store credit account, etc.

Scanning component 230 can scan products, wherein in response to a product of the products being scanned, the product is added to a set of shopping cart items. For example, a product could be scanned by reading a UPC, a magnetic tag, a radio frequency identification tag, etc. As products are scanned, they can be added to a set of shopping cart items. The set of shopping cart items can also include information such as quantity, item price, tax status, perishable expiration dates, nutritional information, etc. In one implementation, as items are removed from the court, they can be removed the list. Items can be detected as removed, or in one implementation, customers can scan items as they are removed from the court.

Display component 240 can facilitate presentation of the set of shopping cart items and the transaction limit. For example, a list of current items in the cart can be displayed along with the transaction limit. Information related to the shopping cart items can also be displayed such as quantity, item price, tax status, perishable expiration dates, nutritional information, etc.

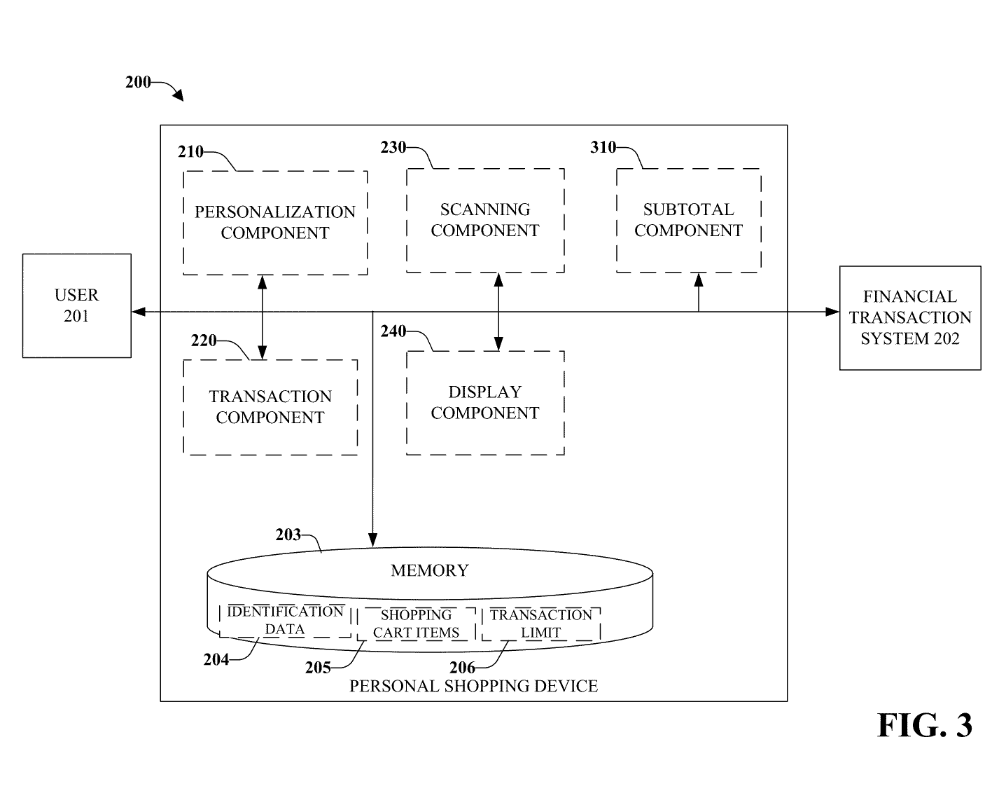

Referring now to FIG. 3, there is illustrated an example personal shopping device including a subtotal component. Subtotal component 310 can determine a subtotal based on the set of shopping cart items. For example, it can use a tax status associated with items to determine an effective tax amount for the set of shopping cart items. It can be appreciated that varying jurisdictions can tax products at different rates. For example, in some jurisdictions foodstuffs are not taxes; however, food that is prepared is. It can be appreciated that providing an accurate subtotal can involved pre-established algorithms based on products, products types, and locations. In one implementation, display component 240 can further facilitate presentation of the subtotal.

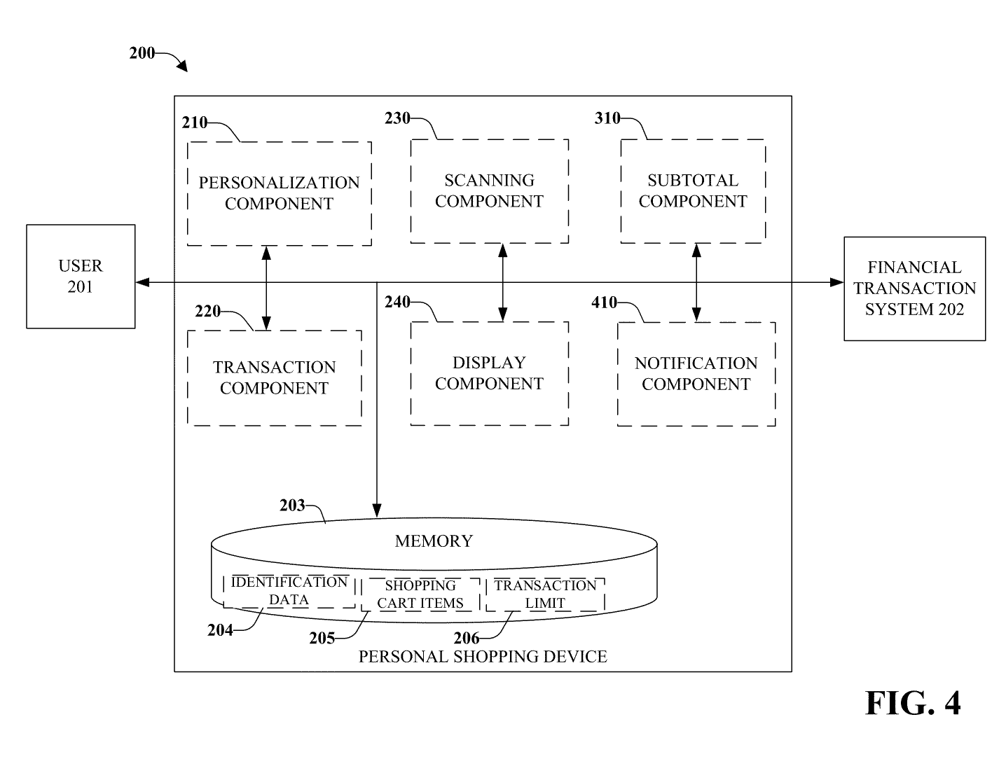

Referring now to FIG. 4, there is illustrated an example personal shopping device including a notification component. Notification component 410 can trigger a user alert based on the subtotal and the transaction limit. For example, in one implementation, display component 240 can facilitate presentation of the user alert. In another implementation, the user alert can be audible. In another implementation, the user alert can be sent electronically to a user associated with the identification data. For example, an email or an SMS message can be sent to the user.

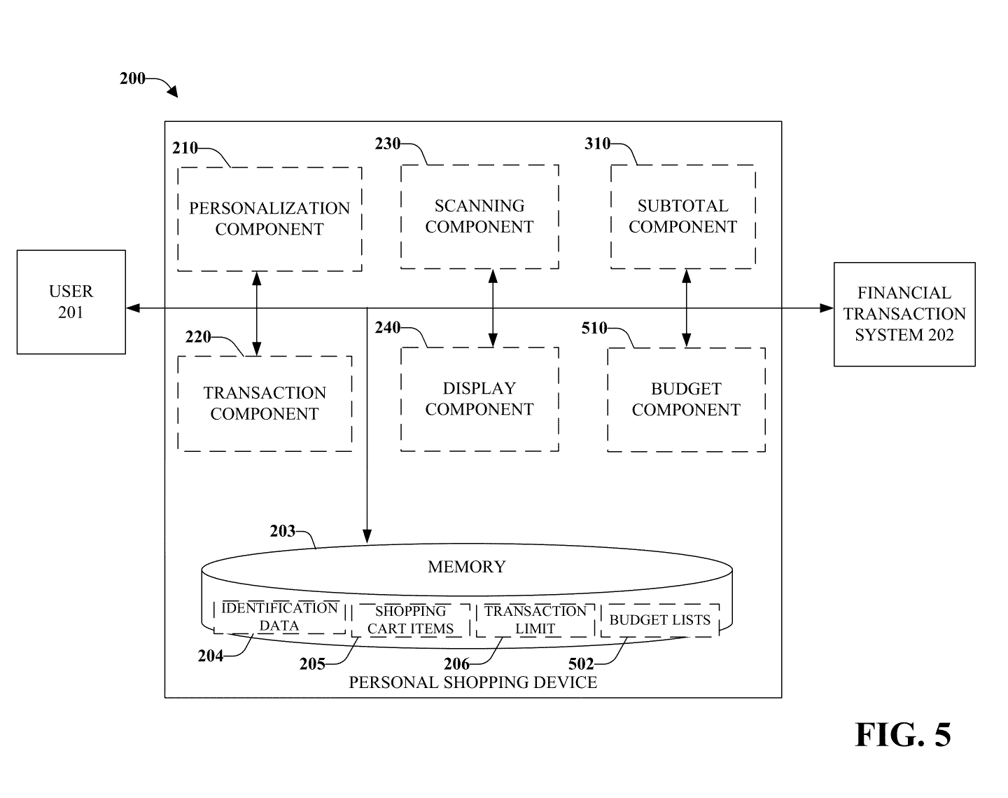

Referring now to FIG. 5, there is illustrated an example personal shopping device including a budget component. Budget component 510 can generate a set of budget lists based on the subtotal, the transaction limit, and the shopping item data wherein a budget list in the set of budget lists includes a subset of items from the set of items. For example, a budget list can be a set of items that if removed from the shopping cart allow the user to be within his or her transaction limit. In another example, the budget list can be a list of items that if stay in the cart are within the user's transaction limit. It can be appreciated that multiple versions of the lists can be generated. For example, if the transaction limit has been reached with 15 products in the shopping cart, their might be many different combinations or subsets of the products that are within the transaction limit. In another example, if the transaction limit has been reached with 60 items in the shopping cart, there might be many different combinations or subsets of the products that are within the cart that could be removed to stay under the transaction limit.

In one implementation, display component 240 can further facilitate presentation of the set of budget lists. For example, the budget lists can be presented as lists of items along with pricing information, tax information, nutritional information, etc. that can assist a user of the device in selection a product or products to remove from the shopping cart. In one implementation, a product purchase history associate with the identification data can be used to make suggestions to the user of products to be removed. For example, items that are routinely purchased may be less suggested as removable versus items that are rarely purchased by the customer. It can be appreciated that user preferences can be established whereby certain products or type of products are more or less suggested as removable when a transaction limit is reached.

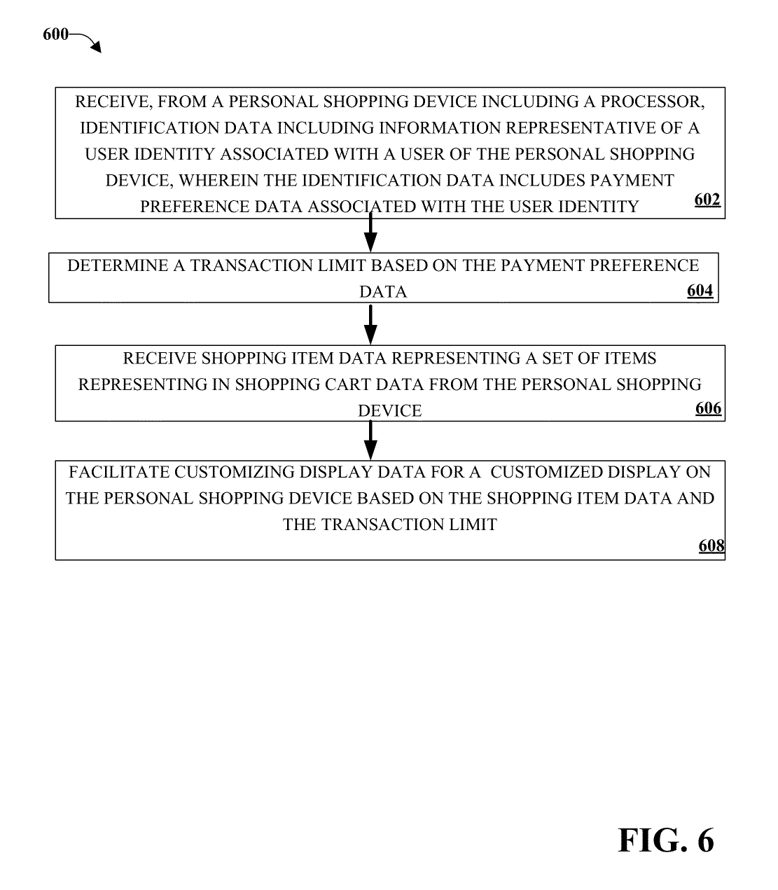

FIGS. 6-9 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 6, there is illustrated an example flow diagram method for generating and using shopping cart lists. At 602, identification data, including information representative of a user identity associated with a user of a personal shopping device can be received, wherein the identification data includes payment preference data associated with the user identity. At 604, a transaction limit can be determined based on the payment preference data. In one implementation, the determining the transaction limit includes sending authorization data to a financial services provider, wherein the authorization data includes the identification data, and receiving the transaction limit from the financial services provider in response to the sending. In one implementation, a hold of funds can be requested with the financial services provider, and when authorized, the transaction limit can established as the amount of funds on hold. In one implementation, the determining the transaction limit includes sending authorization to a secure shopping system wherein the authorization data includes the identification data, and receiving the transaction limit from the secure shopping system in response to the sending.

At 606, shopping item data representing a set of items represented in shopping cart data from the personal shopping device can be received. At 608, display data can be customized for a customized display on the personal shopping device based on the shopping item data and the transaction limit.

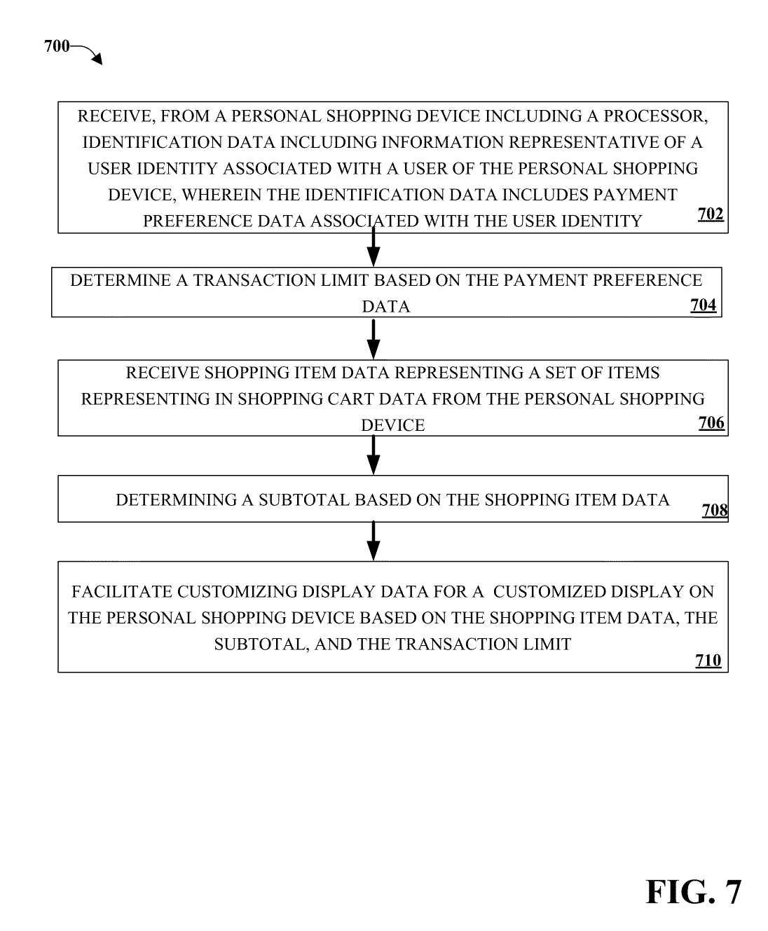

Referring now to FIG. 7, there is illustrated an example flow diagram method for generating and using shopping cart lists including determining a subtotal. At 702, identification data, including information representative of a user identity associated with a user of a personal shopping device can be received, wherein the identification data includes payment preference data associated with the user identity. At 704, a transaction limit can be determined based on the payment preference data. At 706, shopping item data representing a set of items represented in shopping cart data from the personal shopping device can be received. At 708, a subtotal can be determined based on the shopping item data. At 710, display data can be customized for a customized display on the personal shopping device based on the shopping item data, the transaction limit, and the subtotal.

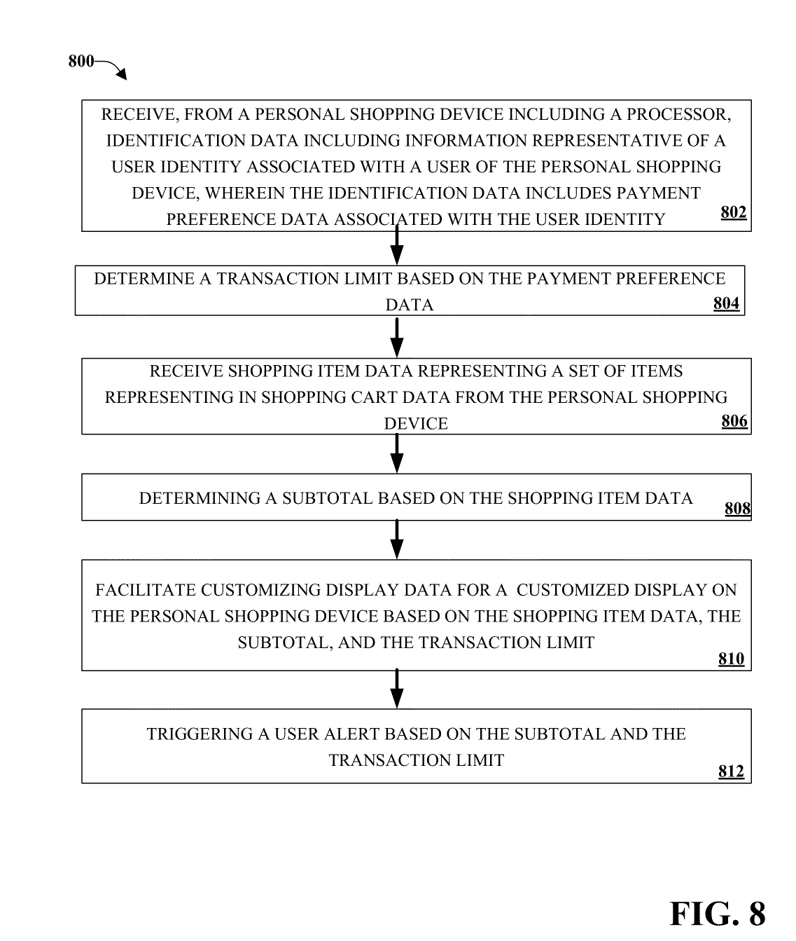

Referring now to FIG. 8, there is illustrated an example flow diagram method for generating and using shopping cart lists including triggering user alerts. At 802, identification data, including information representative of a user identity associated with a user of a personal shopping device can be received, wherein the identification data includes payment preference data associated with the user identity. At 804, a transaction limit can be determined based on the payment preference data. At 806, shopping item data representing a set of items represented in shopping cart data from the personal shopping device can be received. At 808, a subtotal can be determined based on the shopping item data. At 810, display data can be customized for a customized display on the personal shopping device based on the shopping item data, the transaction limit, and the subtotal. At 812, a user alert can be triggered based on the subtotal and the transaction limit.

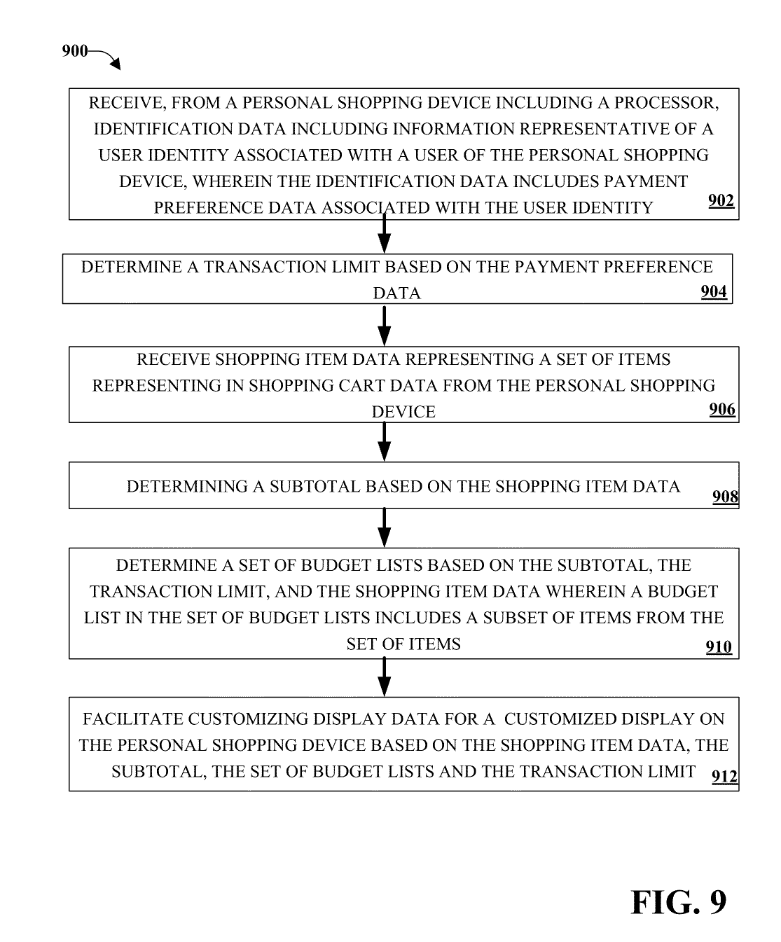

Referring now to FIG. 9, there is illustrated an example flow diagram method for generating and using shopping cart lists including generating and displaying budget lists. At 902, identification data, including information representative of a user identity associated with a user of a personal shopping device can be received, wherein the identification data includes payment preference data associated with the user identity. At 904, a transaction limit can be determined based on the payment preference data. At 906, shopping item data representing a set of items represented in shopping cart data from the personal shopping device can be received. At 908, a subtotal can be determined based on the shopping item data.

At 910, a set of budget lists can be determined based on the subtotal, the transaction limit, and the shopping item data wherein a budget list in the set of budget lists includes a subset of items from the set of items. In one implementation, a cost associated with budget lists in the set of budget lists is greater than the difference between the subtotal and the transaction limit. In one implementation, a cost associated with budget lists in the set of budget lists is less than the transaction limit. At 912, display data can be customized for a customized display on the personal shopping device based on the shopping item data, the transaction limit, and the subtotal. In one implementation, facilitating customizing display data for the customized display on the personal shopping device is further based on the set of budget lists.

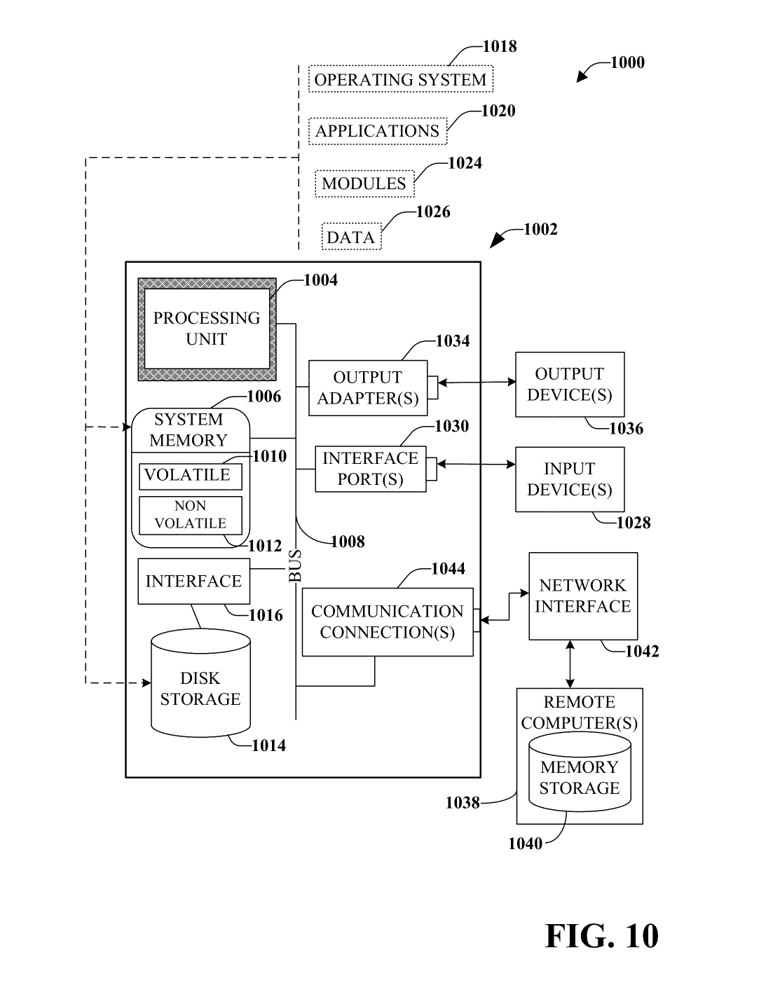

With reference to FIG. 10, a suitable environment 1000 for implementing various aspects of the claimed subject matter includes a computer 1002. The computer 1002 includes a processing unit 1004, a system memory 1006, and a system bus 1008. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1002 may also include removable/non-removable, volatile/non-volatile computer storage media. FIG. 10 illustrates, for example, a disk storage 1014. Disk storage 1014 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1014 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016.

It is to be appreciated that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 1018 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port may be used to provide input to computer 1002, and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

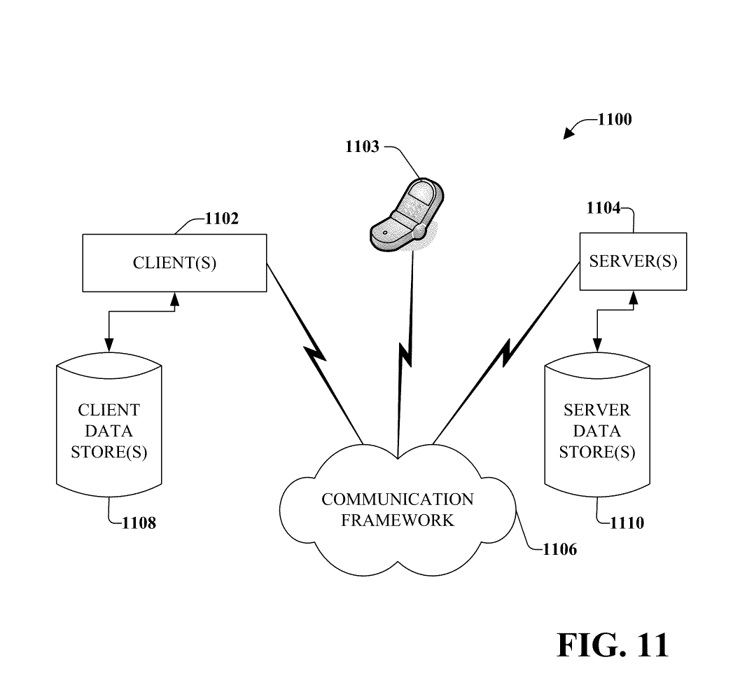

Referring now to FIG. 11, there is illustrated a schematic block diagram of a computing environment 1100 in accordance with the subject specification. The system 1100 includes one or more client(s) 1102, which can include an application or a system that accesses a service on the server 1104. The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware or hardware in combination with software (e.g., threads, processes, computing devices). The servers 1104 can house threads to perform, for example, receiving data, sending data, determining transaction limits, triggering user alerts, etc. One possible communication between a client 1102 and a server 1104 can be in the form of a data packet adapted to be transmitted between two or more computer processes where the data packet contains, for example, a certificate. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A method, comprising:
receiving, from a personal shopping device including a processor, identification data including information representative of a user identity associated with a user of the personal shopping device, wherein the identification data includes payment preference data associated with the user identity;
determining a transaction limit based on the payment preference data;
receiving shopping item data representing a set of items represented in shopping cart data from the personal shopping device; and
facilitating customizing display data for a customized display on the personal shopping device based on the shopping item data and the transaction limit.

2. The method of claim 1, wherein the determining the transaction limit includes sending authorization data to a financial services provider, wherein the authorization data includes the identification data, and receiving the transaction limit from the financial services provider in response to the sending.

3. The method of claim 1, wherein the determining the transaction limit comprises:
sending authorization data to a secure shopping system device, wherein the authorization data includes the identification data, and
receiving the transaction limit from the secure shopping system in response to the sending.

4. The method of claim 1, further comprising:
determining an item subtotal based on the shopping item data.

5. The method of claim 4, further comprising:
triggering a user alert based on the item subtotal and the transaction limit.

6. The method of claim 4, further comprising:
determining a set of budget lists based on the item subtotal, the transaction limit, and the shopping item data, wherein a budget list in the set of budget lists includes a subset of items from the set of items.

7. The method of claim 6, wherein a cost associated with budget lists in the set of budget lists is determined to be greater than a difference between the item subtotal and the transaction limit.

8. The method of claim 6, wherein a cost associated with budget lists in the set of budget lists is determined to be less than the transaction limit.

9. The method of claim 6, wherein the facilitating the customizing of the display data for the customized display on the personal shopping device is further based on the set of budget lists.

10. A personal shopping device, comprising:
at least one memory that stores computer executable components; and
a processor that facilitates execution of one or more computer executable components, the one or more computer executable components comprising:
a personalization component that receives identification data representing a user identity determined to be associated with a user of the personal shopping device, wherein the identification data includes payment preference data associated with the user identity.
a transaction component that sends authorization data to a financial transaction system, wherein the authorization data includes the identification data, and receives a transaction limit from the financial transaction system, in response to the sending;
a scanning component that scans products, wherein in response to a product of the products being scanned, the product is added to a set of shopping cart items; and
a display component that facilitates presentation of the set of shopping cart items and the transaction limit.

11. The personal shopping device of claim 10, wherein the personal shopping device is at least one of a smart phone, or a tablet computer, or a transponder device.

12. The personal shopping device of claim 10, further comprising:
a subtotal component that determines an item subtotal based on the set of shopping cart items.

13. The personal shopping device of claim 12, further comprising:
a notification component that triggers an alert for the user identity based on the item subtotal and the transaction limit.

14. The personal shopping device of claim 12, further comprising:
a budget component that generates a set of budget lists based on the item subtotal, the transaction limit, and the shopping item data wherein a budget list in the set of budget lists includes a subset of items from the set of items.

15. The personal shopping device of claim 14, wherein the display component further facilitates presentation of the set of budget lists.

16. A computer-readable storage medium comprising computer-executable instructions that, in response to execution, cause a computing system comprising a processor to perform operations, comprising:
receiving, from a personal shopping device, identification data including information representative of a user identity associated with a user of the personal shopping device, wherein the identification data includes payment preference data associated with the user identity;
determining a transaction limit associated based on the payment preference data;
receiving shopping item data representing a set of items represented in shopping cart data from the personal shopping device; and
facilitating customizing display data for a customized display on the personal shopping device based on the shopping item data and the transaction limit.

17. The computer-readable storage medium of claim 16, wherein the determining the transaction limit comprises:
sending authorization data to a device associated with a financial services provider, wherein the authorization data includes the identification data, and
receiving the transaction limit from the financial services provider in response to the sending.

18. The computer-readable storage medium of claim 16, wherein the determining the transaction limit comprises:
sending authorization data to a device of a secure shopping system, wherein the authorization data includes the identification data, and
receiving the transaction limit from the secure shopping system in response to the sending.

19. The computer-readable storage medium of claim 16, further comprising:
determining an item subtotal based on the shopping item data.

20. The computer-readable storage medium of claim 19, further comprising:
triggering a user alert based on the item subtotal and the transaction limit.

21. The computer-readable storage medium of claim 19, further comprising:
determining a set of budget lists based on the item subtotal, the transaction limit, and the shopping item data wherein a budget list in the set of budget lists includes a subset of items from the set of items.

22. The computer-readable storage medium of claim 21, wherein the facilitating the customizing of the display data for the customized display on the personal shopping device is based on the set of budget lists.

23. The computer readable storage medium of claim 17, further comprising:
requesting a hold amount with the financial services provider, wherein the transaction limit received is based on the hold amount.
